(19) United States
(12) Patent Application Publication
(10) Pub. No.: US 2023/0169361 A1
(43) Pub. Date: Jun. 1, 2023

(54) GENERATING ANSWERS TO MULTI-HOP CONSTRAINT-BASED QUESTIONS FROM KNOWLEDGE GRAPHS

(71) Applicant: Accenture Global Solutions Limited, Dublin (IE)

(72) Inventors: Sayantan A. Mitra, Bengaluru (IN); Roshni Ramesh Ramnani, Bangalore (IN); Shubhashis Sengupta, Bangalore (IN)

(21) Appl. No.: 17/537,168

(22) Filed: Nov. 29, 2021

(51) Int. Cl. G06N 5/04; G06N 5/02; G06F 16/9035; G06N 20/00

(52) U.S. Cl. CPC G06N 5/04; G06N 5/02; G06F 16/9035; G06N 20/00

(57) ABSTRACT

Automated response generation systems and methods are disclosed. The systems can include a deep learning model specially configured to apply embedding techniques to redesign natural language querying systems for use over knowledge graphs. The disclosed systems and methods employ knowledge graph embedding to reduce knowledge graph sparsity by performing missing link prediction. The systems and methods described generate query graphs with increased flexibility and the ability to handle multi-hope constrained-based queries.

### TECHNICAL FIELD

The present disclosure generally relates to the use of knowledge graphs in automated response generation systems. More specifically, the present disclosure relates to a system and method for providing responses to multi-hop constrained-based queries using knowledge graph embeddings.

### BACKGROUND

Reasoning and inference are central to both human and artificial intelligence. Natural language querying over knowledge graphs is essential for the human consumption of the broad expanse of information currently available. To perform this type of query, a natural language query is typically converted to a structured query and submitted to the knowledge graph. However, among other issues, user inputs that involve complex questions are typically handled by a system that is unable to process multiple types of complexities. In other words, standard complex question answering systems address each of the two types of complex queries—questions with constraints or questions involving multiple-hops of relations—separately. Thus, automatic generation of accurate responses to queries has continued to represent a challenging problem in artificial intelligence.

There is a need in the art for a system and method that addresses the shortcomings discussed above.

### SUMMARY

In the context of this disclosure, an automated response generation system can include embedding-based query graph generation to address complex questions dealing with both multiple-hops and constraints. Because knowledge graphs are generally incomplete or sparsely populated, such that complex questions relying on systems employing knowledge graphs have been inadequate. The proposed use of embedding effectively addresses the knowledge graph sparsity problem by predicting missing links without the use of a secondary corpus. The system trains on the knowledge graph entity embedding and uses it to learn question embeddings. Consequently, the proposed model generates a set of all possible relations and entities. Furthermore, the system generates all possible query graphs using the generated set of relations and entities to handle complex questions with both multi-hop relations and constraints. In addition, by strategic incorporation of constraints into the query graphs, the search space can be restricted, increasing processing speed and decreasing the need for storage.

In one aspect, the disclosure provides a computer-implemented method of generating answers to multi-hop constraint-based questions by a question-and-answer system (QAS) using knowledge graphs. The method includes a first step of accessing, by the QAS, a knowledge graph. The QAS can be hosted, for example, on a cloud-server or a local computing device. A second step includes generating, at the QAS, a set of knowledge graph embeddings based on the knowledge graph via a knowledge graph embedding model, and a third step includes receiving, at the QAS and from a user device, a natural language query question having one or more words. The method also includes a fourth step of transforming, at the QAS, the one or more words into one or more question embeddings, where each embedding is a vector representing a corresponding word, and a fifth step of identifying, at the QAS, at least a first constraint and a topic entity in the question embeddings. A sixth step includes identifying, at the QAS, a plurality of core relation paths in the knowledge graph embeddings, where each path links the topic entity to a different ungrounded entity, and a seventh step includes associating, at the QAS, the first constraint with each of the core relation paths to generate a plurality of query graphs including at least a first query graph, where each query graph is based on a combination of question embeddings and knowledge graph embeddings. The method further includes an eighth step of ranking, at the QAS, the plurality of query graphs using a CNN-based similarity scoring model, a ninth step of determining, based on a top-ranked query graph and at the QAS, an answer to the query, and a tenth step of presenting, via the user device and from the QAS, the answer.

In yet another aspect, the disclosure provides a non-transitory computer readable medium storing software that may comprise instructions executable by one or more computers which, upon execution, cause the one or more computers to: (1) access, by a question-and-answer system (QAS), a knowledge graph; (2) generate, at the QAS, a set of knowledge graph embeddings based on the knowledge graph via a knowledge graph embedding model; (3) receive, at the QAS and from a user device, a natural language query question having one or more words; (4) transform, at the QAS, the one or more words into one or more question embeddings, each embedding being a vector representing a corresponding word; (5) identify, at the QAS, at least a first constraint and a topic entity in the question embeddings; (6) identify, at the QAS, a plurality of core relation paths in the knowledge graph embeddings, each path linking the topic entity to a different ungrounded entity; (7) associate, at the QAS, the first constraint with each of the core relation paths to generate a plurality of query graphs including at least a first query graph, each query graph being based on a combination of question embeddings and knowledge graph embeddings; (8) rank, at the QAS, the plurality of query graphs using a CNN-based similarity scoring model; (9) determine, based on a top-ranked query graph and at the QAS, an answer to the query; and (10) present, via the user device and from the QAS, the answer.

In yet another aspect, the disclosure provides a system for generating answers to multi-hop constraint-based questions, the system comprising one or more computers and one or more storage devices storing instructions that may be operable, when executed by the one or more computers, to cause the one or more computers to: (1) access, by a question-and-answer system (QAS), a knowledge graph; (2) generate, at the QAS, a set of knowledge graph embeddings based on the knowledge graph via a knowledge graph embedding model; (3) receive, at the QAS and from a user device, a natural language query question having one or more words; (4) transform, at the QAS, the one or more words into one or more question embeddings, each embedding being a vector representing a corresponding word; (5) identify, at the QAS, at least a first constraint and a topic entity in the question embeddings; (6) identify, at the QAS, a plurality of core relation paths in the knowledge graph embeddings, each path linking the topic entity to a different ungrounded entity; (7) associate, at the QAS, the first constraint with each of the core relation paths to generate a plurality of query graphs including at least a first query graph, each query graph being based on a combination of question embeddings and knowledge graph embeddings; (8) rank, at the QAS, the plurality of query graphs using a CNN-based similarity scoring model; (9) determine, based on a top-ranked query graph and at the QAS, an answer to the query; and (10) present, via the user device and from the QAS, the answer.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of an overview of a framework for a knowledge graph-based question and answer system, according to an embodiment;

FIG. 2 is a diagram of an example of a linking process, according to an embodiment;

FIG. 3 is a schematic diagram representing an example of a query graph generated using the proposed model, according to an embodiment;

FIGS. 4A, 4B, and 4C depict examples of three actions, including extend, connect, and aggregate, according to an embodiment;

FIG. 5 is a flow chart presenting a method of providing automatic responses to a query, according to an embodiment; and

FIG. 6 is a diagram depicting example environments and components by which systems and/or methods, described herein, may be implemented.

### DESCRIPTION OF EMBODIMENTS

Conversation systems such as those providing virtual chatbots or intelligent query-and-answer models are relied upon more and more by users in their day-to-day lives, as well as by businesses, researchers, and other organizations to retrieve information. Knowledge graphs (KGs) are used to store information about a wide variety of subjects. Extraction of answers from a given knowledge graph using available question-and-answer (QA) systems traditionally requires a translation of the natural language questions into a formal representation of a query. However, knowledge graphs typically require large storage capacity, and determining all possible answer combinations is a prohibitive process. In addition, KGs are often incomplete, as it is difficult to integrate all the concepts that humans have formed, and real-world data are often dynamic and evolving, making it difficult to construct a complete and correct knowledge source. Furthermore, conventional approaches have not been practically extendable to multi-hop settings. Thus, the accuracy and capability of these systems has remained a problem. While external text corpus as knowledge source in addition to KG can be used to answer complex questions in cases where the KG is sparse or incomplete, such corpora may not be readily available for all domains.

In general, the objective of a Question-Answering system over a Knowledge Graph (KGQA) is to answer natural language queries. A complex question-answering system typically addresses one of two types of complex queries: (a) questions with constraints and (b) questions involving multiple hops of relations. Multi-hop KGQAs require reasoning over multiple edges of the KG to arrive at the correct answer. However, KGs are usually sparse, posing challenges for the implementation of multi-hop KGQA. As will be discussed in detail below, KG embedding is used to reduce KG sparsity by performing missing link prediction. The proposed embodiments are configured to address multi-hop constrained-based queries using KG embeddings to generate more flexible query graphs. Test data measuring the performance of the proposed systems has shown state-of-the-art results when implemented with three benchmark KGQA datasets.

As a general matter, a knowledge graph (“KG”) can refer to a representation that captures the salient knowledge about a particular task. A knowledge graph is a structured representation of facts, consisting of entities, relationships and semantic descriptions. Entities can be real-world objects and abstract concepts, relationships represent the relation between entities, and semantic descriptions of entities and their relationships contain types and properties with a well-defined meaning. The knowledge graph includes an array of interconnected nodes and each connection represents a relationship with its own properties or attributes.

As will be discussed below, in some embodiments, a portion of the knowledge graph that includes group of nodes can be isolated or extracted, where each node represents various properties, objects, subjects, and constraints, in order to respond to a specific query. In many cases, knowledge graphs can store and convey in a single network a large collection of information. As some examples, a knowledge graph encodes the domain entities, relationships, processes, and polices for a given business or organization. A generic semantic natural language processing engine can then be applied to user queries and retrieve the correct results from the knowledge graph. In addition, the nodes will be connected to other nodes by an “edge” line, also referred to herein as a transitional path or transitional edge. For example, a first node will be connected to a second node by a transitional path. Thus, a knowledge graph may provide an organized graph that ties nodes and edges, where a node may be related to semantic concepts, such as persons, objects, entities, events, etc., and an edge may be defined by relations between nodes based on semantics. It should be appreciated that, as described herein, the term “node” may be used interchangeably with “entity,” and “edge” with “relation.” Furthermore, classifications may provide assignment of instances to pre-defined classes to decide whether there are matches or correlations.

In some examples, a knowledge graph is a collection of data and related content that is based on a schema representing entities and relationships between entities. The data can be logically described as a graph (even though also provided in table form), in which each distinct entity is represented by a respective node, and each relationship between a pair of entities is represented by an edge between the nodes. Each edge is associated with a relationship and the existence of the edge represents that the associated relationship exists between the nodes connected by the edge. For example, if a node A represents a person Alpha, a node B represents a person Beta, and an edge E is associated with the relationship “is the father of,” then having the edge E connect the nodes in the direction from node A to node B in the graph represents the fact that Alpha is the father of Beta. In some examples, the knowledge graph can be enlarged with schema-related knowledge (e.g., Alpha is a concept Person, Beta is a concept Person, and “is the father of” is a property or relationship between two entities/instances of concept Person). Adding schema-related information supports evaluation of reasoning results.

A knowledge graph can be represented by any of a variety of physical data structures. For example, a knowledge graph can be represented by triples that each represent two entities in order, and a relationship from the first to the second entity; for example, [alpha, beta, is the father of], or [alpha, is the father of, beta], are alternative ways of representing the same fact. Each entity and each relationship can be, and generally will be, included in multiple triples.

In some examples, each entity can be stored as a node once, as a record or an object, for example, and linked through a linked list data structure to all the relationships the entity has, and all the other entities to which the entity is related. More specifically, a knowledge graph can be stored as an adjacency list in which the adjacency information includes relationship information. In some examples, each distinct entity and each distinct relationship are represented with respective, unique identifiers.

The entities represented by a knowledge graph need not be tangible things or specific people. The entities can include particular people, places, things, artistic works, concepts, events, or other types of entities. Thus, a knowledge graph can include data defining relationships between people (e.g., co-stars in a movie); data defining relationships between people and things (e.g., a particular singer recorded a particular song); data defining relationships between places and things (e.g., a particular type of wine comes from a particular geographic location); data defining relationships between people and places (e.g., a particular person was born in a particular city); and other kinds of relationships between entities.

In some embodiments, each node has a type based on the kind of entity the node represents; and the types can each have a schema specifying the kinds of data that can be maintained about entities represented by nodes of the type and how the data should be stored. For example, a node of a type for representing a person could have a schema defining fields for information such as birth date, birth place, and so on. Such information can be represented by fields in a type-specific data structure, or by triples that look like node-relationship-node triples (e.g., [person identifier, was born on, date]), or in any other convenient predefined way. In some examples, some or all of the information specified by a type schema can be represented by links to nodes in the knowledge graph, for example, [one person identifier, child of, another person identifier], where the other person identifier is a node in the graph.

Thus, a KG refers to a multi-relational graph comprising of a large number (often millions) of entities and relations represented in the form of triplets (entity-relation-entity). More specifically, a knowledge graph can be expressed where G is a set of triples K, such that K⊆E×R×E, and E and R are sets of entities and relations respectively. A triple is represented by (h, r, t), where h and t represent subject and object (h, t∈E) and r represents the relation between them. Some of the most widely used KGs include DBPedia, Freebase 1, YAGO, KENSHO2 and NELL, although others can also be used. Given a natural language question, a KGQA system derives the right answer by analyzing the question and mapping it to the underlying KG. Simple questions containing single relations have been addressed by conventional systems; however, in the real world, questions are often complex. As noted above, the complexities in KGQA can broadly be divided into two types. The first type—constraint-based—refer to single relation questions with constraints. For example, in the question “Who was the first president of the U.S.?” there is only one relation (“president of”) between the answer entity and the entity “U.S” but we also have the constraint “first” that needs to be satisfied. The second type—multi-hop-based—involve queries with multi-hop answers. For example, consider the question “Who is the wife of the founder of Facebook®?” The answer is associated with the entity “Facebook®” through two hops of relations, namely, “wife of” and “founder of”. For addressing such multi-hop questions, longer graph paths must be traveled. However, this depends on a search space that can grow exponentially with the length of the relation paths. It is therefore necessary to restrict the multi-hop relations that are to be considered.

The proposed embodiments are configured to handle both types of complexities together using an embedding-based graph query generation method that supports longer relation paths. However, rather than adding constraints after the complete generation of all probable paths, constraints are applied on partial paths and then used to explore the next path segments. Such an approach significantly reduces the query search space needed to produce answers. Furthermore, the proposed embodiments leverage the requirement of answer selection from a pre-specified local neighborhood (an auxiliary constraint).

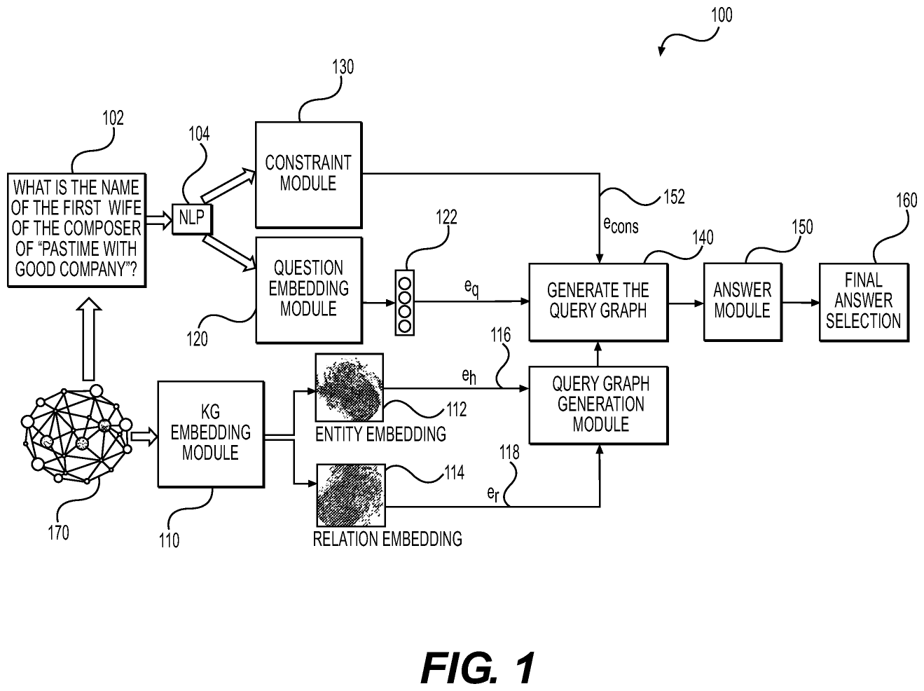

For purposes of introduction, FIG. 1 presents a schematic overview of an embodiment of the proposed system framework (“system”) 100 for implementing a constraint based multi-hop KGQA. In different embodiments, the system 100 can be supported by a technology stack that includes a programming language (e.g., Python 3, Java, JavaScript, Perl, Tcl, Smalltalk, etc.) and a deep learning package (e.g., PyTorch, TensorFlow, Keras, Caffe2, MXNet, and Torch, etc.). In other embodiments, different programming languages and deep learning packages may be used. As illustrated in system 100, natural language querying over KGs is approached from the perspective of a graph embedding method. In the embodiment shown in FIG. 1, it can be seen that the framework includes five modules: a KG Embedding Module 110, which learns embeddings of all entities and relations in KG, and a Question Embedding Module 120 which learns an embedding for the question, where graph embeddings help our proposed method to effectively handle KG sparsity, a Constraint Module 130 for detecting and identifying constraints in the question, a Query Graph Generation Module 140 which generates the relevant query graphs based on the question, and an Answer Module 150 which selects the top-k graphs and generates the final answer.

As a general matter, the system 100 is configured handle the task of extracting an entity that correctly answers the given query. More specifically, for a KG identified as “ [symbol] ”, ε is the set of all entities and [symbol] is the set of all relations. In addition, K⊆ε× [symbol] ×ε are the set of available facts in [symbol] . The problem the system 100 will solve, given a natural language question q having a topic entity eₕ★ε and zero or more constraints, can then be restated as the task of extracting an entity eₜ∈ε that correctly answers the question q.

In different embodiments, the system 100 also includes or has access to a knowledge graph or other information database (“KG database”) 170, as well as a natural language processing (NLP) module 104 which receives and translates queries and prepares natural language answers. In some embodiments, the proposed system is configured convert a question 102 (in this example, “What is the name of the first wife of the composer of ‘Pastime with Good Company?’”) on KG for processing by the constraint module 130 and question embedding module 120.

In different embodiments, when a query is received by the system 100, a series of steps involving both an entity extraction and linking process can occur. For example, a processing module can access data related to relevant entities and relationships from the KG database 170 in order to perform its tasks. In some embodiments, as a natural language query is received by NLP processing module 104, an entity extraction and linking submodule automatically identifies and extracts entities and relations between entities within the text of each of the multiple nodes of the KG. in different embodiments, the submodule may apply one or more Named Entity Recognition (NER) and Relationship Extraction processes for information extraction, such as but not limited to linguistic grammar-based techniques and statistical models, ontology knowledge models, OpenIE, Bi-LSTM CRF, BERT, etc. To identify and extract entities the entity extraction and linking submodule may apply natural language processing techniques. The entity extraction and linking submodule may then apply reasoning techniques over multiple knowledge sources to infer question-answer links. In some embodiments, the entity extraction and linking submodule may further score and rank the extracted entities and links to generate a most-representative set of entities and links. In one embodiment, the entity extraction and linking submodule may include a recognition engine component that applies natural language processing techniques or other entity extraction techniques to extract relevant entities and supporting entities from the KG. In some cases, the entity extraction and linking submodule may receive a list of extracted entities from the recognition engine component and filter the list of extracted entities by removing irrelevant entities, e.g., lexical terms, short terms, context terms, or entities mentioned in reference. In some cases, the entity extraction and linking submodule may further categorize or label extracted entities in the list of extracted entities. In some cases, technical definitions may be applied that restrict the set of valid paths between such nodes, including simple paths that do not visit the same node twice.

The query graph generation module 140 also receives embedded KG data 114 that are learned from the graph data and help in predicting unknown links and extracting relations from the graph, as well as in capturing paraphrases, hierarchy, logical patterns and similarity in the KG. Such embeddings, including entity embedding 112 and relation embedding 114, can be generated by various toolkits such as but not limited to OpenKE. As a general matter, an embedding refers to a mapping of a discrete—categorical— variable to a vector of continuous numbers. In the context of neural networks, embeddings are low-dimensional, learned continuous vector representations of discrete variables. Typically, neural network embeddings have three primary purposes: finding nearest neighbors in the embedding space to make recommendations based on user interests or cluster categories, to produce input to a machine learning model for a supervised task, and for visualization of concepts and relations between categories. The accuracy and quality of embeddings are improved by learning them using a neural network on a supervised task. The embeddings form the parameters—weights—of the network which are adjusted to minimize loss on the task. The resulting embedded vectors are representations of categories where similar categories—relative to the task—are closer to one another.

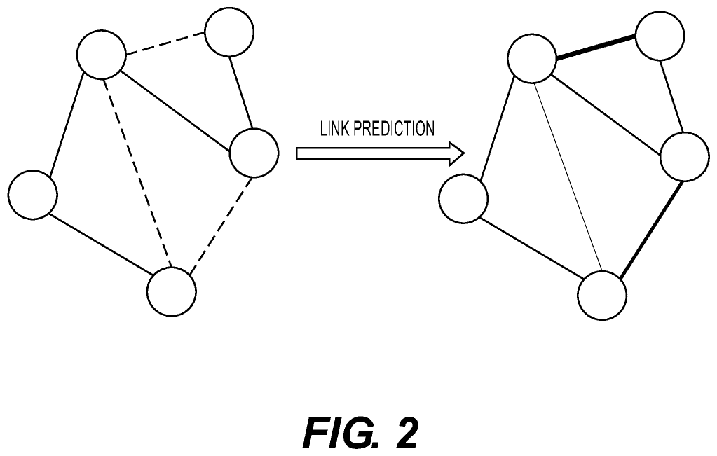

As noted above, it is a challenging task to automatically construct a complete KG; this is often formulated as the link-prediction problem. The goal of link prediction is to predict missing links or relations between the entities in KGs. In one embodiment, the general framework involves defining a scoring function for a set of triplets h, r, t in a KG such that the correct triples get higher scores compared to the incorrect triples. For a given incomplete KG, the task of the link prediction is to predict the valid unknown links. This task is achieved by KG embedding models which assign a score s=ϕ(h, r, t)∈R to the predicted links and validate whether the link is true. Thus, the goal of this model is to predict the missing links correctly. A link prediction process is schematically represented in FIG. 2, where an example of link prediction is depicted. On the left side, the three solid lines represent the existing relations, and the three dotted lines represent the predicted relations. On the right side, the three lines of varying boldness represent the predicted links which are calculated by the link-prediction task.

In this way, several different stages of the process for predicting links in knowledge graphs are automated, which may remove human subjectivity and waste from the process, and which may improve speed and efficiency of the process and conserve computing resources (e.g., processors, memory, and/or the like). Furthermore, implementations described herein use a rigorous, computerized process to perform tasks or roles that were not previously performed or were previously performed using subjective human intuition or input. These roles may include predicting links in knowledge graphs without having to retrain the knowledge graphs, utilizing the predicted links to answer queries, and/or the like. Finally, automating the process for predicting links in knowledge graphs conserves computing resources (e.g., processors, memory, and/or the like) that would otherwise be wasted in retraining the knowledge graphs.

Returning to FIG. 1, it can be seen that the proposed method uses graph embeddings to answer complex (both constrained based and multi-hop) natural language questions. In a first stage, the system 100 learns a KG representation in the embedding space via KG embedding module 110. As a general matter, in machine learning, knowledge graph embedding models predict existences of labeled links between entities. Such predictions are a result of operations between points (e.g., known as embeddings) in a metric space. The embeddings are learned from the entire knowledge graph during training of the knowledge graph. However, a knowledge graph embedding model is unable to predict links associated with a new unknown entity. In such cases, an embedding model of the knowledge graph cannot predict the links because the unknown entity is not known during the training of the knowledge graph, and the embedding model did not learn a corresponding representation in the metric space. Some techniques handle unknown entities by completely retraining the knowledge graph. Unfortunately, such techniques consume significant time and resources (e.g., processors, memory, and/or the like) in order to retrain the knowledge graph. Furthermore, the embedding model of the knowledge graph relies on architectures that are ill-suited to provide effective explanations of predicted links to end users.

Some embodiments described herein provide a prediction platform that determines explanations for predicted links in knowledge graphs. For example, the prediction platform may receive a knowledge graph generated based on training data and an ontology for the training data, and may receive a query for information associated with the knowledge graph. The prediction platform may generate candidate responses to the query based on the knowledge graph, and may score the candidate responses based on the knowledge graph. The prediction platform may determine, based on the knowledge graph, a neighborhood of the particular candidate response, and may generate knowledge graph embeddings for the neighborhood of the particular candidate response. The prediction platform may determine a particular neighborhood with a smallest loss of quality based on the knowledge graph embeddings. The prediction platform may generate a reasoning graph based on the ontology and the particular neighborhood, and may generate an explanation of the particular candidate response based on the reasoning graph. A diagram schematically depicting an example of link prediction is shown in FIG. 2.

In one embodiment, the prediction platform may receive a knowledge graph. In some embodiments, the knowledge graph may be serialized into a list of statements, and the list of statements may be received by the prediction platform. An embedding engine may generate knowledge graph embeddings based on the knowledge graph. In some implementations, the knowledge graph embeddings may include points in a k-dimensional metric space, and may provide latent semantic representations for structured knowledge in the knowledge graph. In some implementations, the knowledge graph embeddings may enable direct explicit relational inferences among entities via simple calculation of embedding vectors, and may be effective at highlighting key concepts underlying sophisticated human language. Additional details regarding link prediction and other aspects of embodiments of the disclosed framework can be found in U.S. Pat. No. 10,877,979 to Costabello et al., granted Dec. 29, 2020 and titled “Determining explanations for predicted links in knowledge graphs”, and U.S. Pat. No. 10,157,226 to Costabello et al., granted Dec. 18, 2018 and titled “Predicting links in knowledge graphs using ontological knowledge”, both applications of which are hereby incorporated by reference in their entirety.

In some embodiments, the system 100 employs knowledge-graph embedding to generate longer relation paths. In one example, knowledge-graph embedding involves embedding the components (e.g., the nodes and the edges between them) of a knowledge graph into continuous vector spaces, to simplify the manipulation while preserving the inherent structure of the knowledge graph. Such knowledge-graph embedding places the nodes in a dimensional metric space to determine a position for each of the nodes. Once this position is determined, links between the nodes can be predicted. This information can then be used to identify and quantify matches (e.g., a value representing the percentage matching) between various nodes of the knowledge graph and the nodes corresponding to, for example, each entity in the query.

In another example, the system 100 is configured to transform knowledge graph information into binary-valued embedding vectors and using the binary-valued embedding vectors to efficiently provide accurate answers during a question-and-answer session. For example, a binary-valued embeddings generation submodule of the knowledge graph embedding module 110 can perform a series of steps to transform a knowledge graph nodes and edges into binary-valued embedding vectors. Some example steps include indexing each node a value V; initializing a D-dimensional vector for each node to form a matrix E of size V×D; initializing the matrix E with uniform random values; optimizing the matrix and generating embedding approximation values for each node; and transforming the embedding approximation values into binary-valued embedding vectors. Thus, when the system 100 receives a question 102 that requests nodes similar to “A” a node lookup submodule locates an entry for node A in the KG embeddings and retrieves node A's corresponding binary-valued embedding vector. The node corresponding to the matching vector is then identified.

In addition, for the given question 102, the system 100 learns the question embedding via question embedding module 120 and also identifies the topic entities in a second stage. In some embodiments, the question embedding module 120 can include one or more of a word embedding layer, a convolution layer, an encoder layer, and an attention layer. In some implementations, the word embedding layer processes individual words of the question 102 to provide respective word embeddings. In some examples, one or more words of the query are removed (e.g., stop words) such that word embeddings are only provided for meaningful words. In general, a word embedding can be described as a mathematical embedding from a space with one dimension per word to a continuous vector space with multiple dimensions. In other words, each word of the query is represented as real-valued vector in a predefined vector space. In some examples, each word is mapped to one vector and the vector values are learned.

In some implementations, the convolution layer includes a convolution neural network (CNN), which learns the internal syntactic structure of sentences based on the word embeddings. This removes reliance on external resources, such as parse trees. In general, CNNs can include an input layer, a set of hidden layers, and an output layer. In some examples, the set of hidden layers can include convolutional layers, a rectified linear unit (RELU) layer (e.g., an activation function), pooling layers, fully connected layers, and/or normalization layers. In some embodiments, the CNN includes a pooling layer (e.g., a maximum pooling layer, an average pooling layer). In general, the pooling layer provides for non-linear down-sampling to reduce a dimensionality of the output of the convolution layer.

In some embodiments, the output of the convolution layer is input to the encoder layer as an input sequence. In some implementations, the encoder layer includes a bi-directional long short-term memory (LSTM) encoder that captures word ordering in both a forward direction and a backwards direction and is able to capture features of n-grams independent of their positions in the sentences. In this manner, the encoder layer captures long-range dependencies, which are common in queries. In some embodiments, the encoder layer includes a sequence-to-sequence deep learning model that may be used for learning use cases associated with sequential learning, where understanding of the meaning of words and text is provided through context of use. The encoder layer can include multiple layers of LSTM cells, where one layer is used to learn in a forward direction, and another layer is used to learn in a reverse direction. The encoder layer provides one or more answers as output, each answer being characterized by specific features/keywords of query.

For relation extraction, training questions and their answers are used to learn the linking model (see FIG. 2) in a third stage. In a fourth stage, regular expressions and a superlative word list are used to learn the temporal constraints and superlative linking. In a fifth stage, the superlative words are manually mapped to the aggregation functions: argmin and argmax. Finally, in a sixth stage, the system 100 combines these embeddings (116, 118) and constraints 132 (obtained via constraint module 130) to predict the answer 160 via answer module 150.

With respect to the KG embedding module 110, complex embeddings for all h, t∈E and all r∈ [symbol] were used such that eₕ, eᵣ, eₜ∈C^{d}. In different embodiments, various KGE (knowledge graph embedding) models may be used, including but not limited to TransE, TransR, RESCAL, DistMult, ComplEx, and RotatE. The model will define different score functions to learn entity and relation embeddings. In one example, the entity embeddings are used to learn a triple scoring function between topic entity, question, and answer entity. The selected triplets are used to generate the query graphs. The entity and relation embeddings learned in this stage are kept fixed and used for fine-tuning subsequent steps. As one example, ComplEx embedding is used, which is a latent factorization method that learns a large variety of symmetric and anti-symmetric relation in complex space. It is used to generate entity and relation embeddings in KGs. Given h, t∈ε and r∈ [symbol] the complex embedding generates eₕ, eᵣ, eₜ∈C^{d} and defines a scoring function, given as Equation (1) below:

$$ϕ ( h , r , t ) = Re ( {\sum }_{k = 1}^{d} {e}_{h}^{( k )} {e}_{r}^{( k )} {\overline{e}}_{t}^{( k )} )$$

For all correct triplets ϕ(h, r, t)>0 and for others ϕ(h, r, t)<0 and Re stands for the real part of the complex numbers.

In addition, the question embedding module 120 is used to map the natural language questions to a fixed dimension vector, eq∈C^{d}. In one example, a pre-trained ROBERTa model is used to map the natural language questions to a fixed dimension is used to embed q into a 768-dimensional vector, which is then passed through three fully-connected linear layers with ReLU activation and a dropout of 0.1 in each layer and finally projected to a complex space C^{d}.

For a question q, topic entity h∈ε and set of answers [symbol] ⊆ε, the question embedding is learned such that:

$$ϕ ( {e}_{h} , {e}_{q} , {q}_{a} ) > 0 ∀ a ∈ \\ ϕ ( {e}_{h} , {e}_{q} , {e}_{\overline{a}} ) < 0 ∀ \overline{a} ∉ \vert$$

where, ϕ is defined in Equation 1 above and eₕ, eₐ are entity embeddings learnt in the previous step. The model is learned by minimizing the binary cross entropy loss between the sigmoid of the scores and the target answer labels. When the entities are large, label smoothing is performed.

In addition, with respect to relation matching, the system 100 learns a scoring function Sᵣ(r,q), for example similar to PullNet, and ranks the relations r∈R for question q. In this case, let q̅={ [symbol] s>w₁, w₂ . . . w_{|q|}</s>}, word sequence in question q and hᵣ be the relation embedding, then the scoring function is defined by Equation (2):

h_{q}=ROBERT a(q̅)

and Equation (3):

Sᵣ(r,q)=sigmoid(h_{q}^{T}hᵣ)

where ROBERT a(.) returns the last hidden layer output of the ROBERTa model. The relations where Sᵣ>0.5 are selected and denoted as Rₐ.

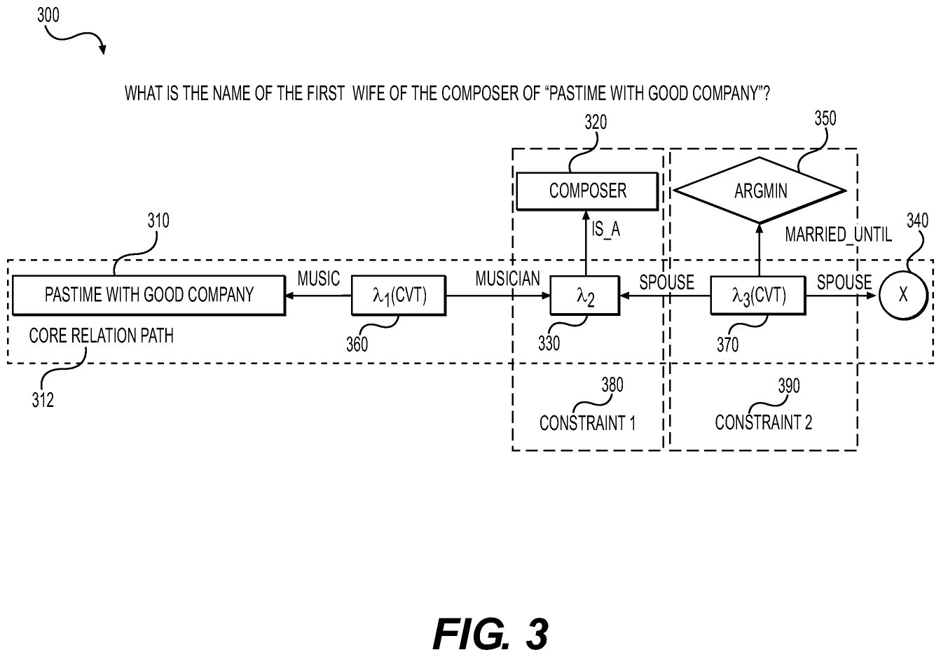

As outputs from the three modules (110, 120, 130) are obtained, the query graph generation 140 will generate the query graph. For a given question Q, the task of the system 100 is to find an answer a such that a∈ε. In some embodiments, the proposed system can implement a staged query generation method to accomplish this. Referring to FIG. 3, the sample query graph 300 for the question “What is the name of the first wife of the composer of ‘Pastime with Good Company’?” is shown. It can be understood that a query graph 300 includes four different nodes. A first node corresponds to a grounded entity node, which is an existing node in KG and explicitly mentioned in the question. A grounded entity is the entity that is explicitly mentioned in the question. For example, in the above-mentioned question the phrase “Pastime with Good Company” 310 and the term “composer” 320 are grounded entities, while the phrase “Pastime with Good Company” 310 is also the topic entity.

An existential node is an ungrounded entity. These types of entities are not explicitly extracted from the question but rather inferred based on the evidence provided in the question. For example, in the given question, the name of the composer, represented as y₂ (330) is an ungrounded entity. In addition, a lambda variable 340 is an ungrounded entity which represents the answer. An aggregation function 350 (argmin/count) operates on a set of entities. The edges of the graph represent the relations r. Generally, a graph query should have a single lambda variable (representing a single answer), at least one grounded entity, and zero or more aggregation functions and existential variables (360, 370).

As shown in FIG. 3, the query graph is formed by first identifying a core relation path 312 linking the grounded (topic) entity to a lambda variable. In this case, the path linking the topic entity “Pastime with Good Company” 310 to the variable lambda 340 is the core relation path. There are two constraints (380, 390) and y₁ and y₃ are compound value type (CVT) nodes used for n-ary relations. After generating the core relation path 312, the next step is to associate one or more constraints (380, 390) found in the question with the core relation path 312. A constraint can either be a grounded entity or an aggregation function along with the relation. After generating all the query graphs these two steps, the graphs are ranked, for example by using a CNN-based similarity scoring model. Finally, the top-ranked query graphs are used to fetch the answer entities from the KG.

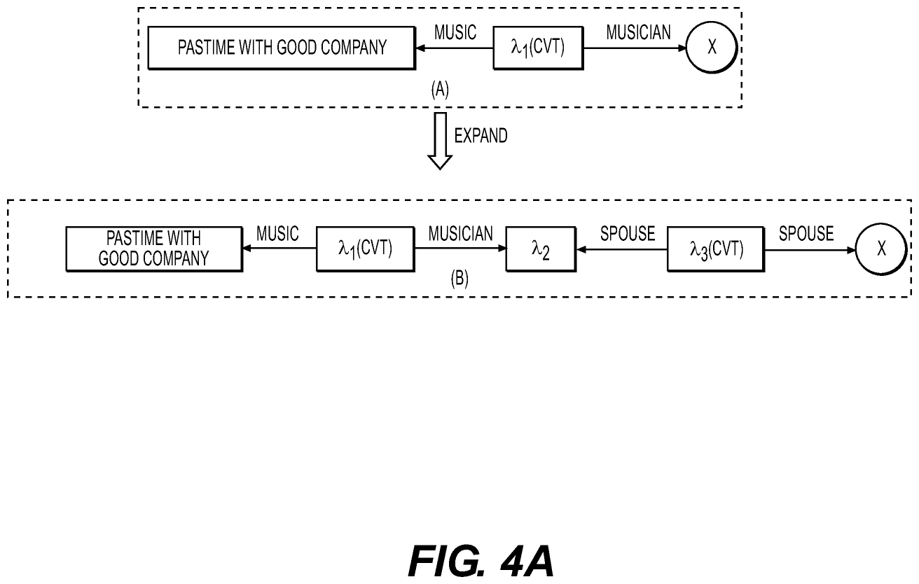

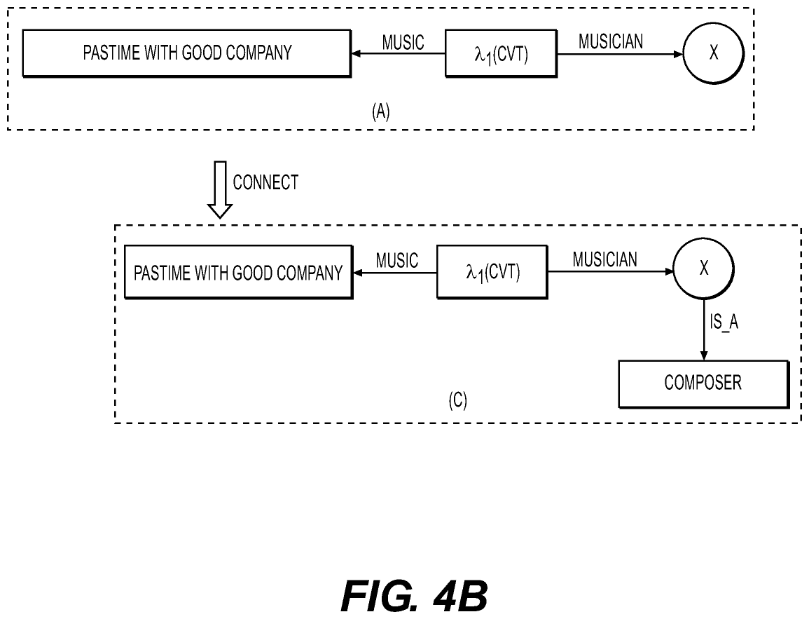

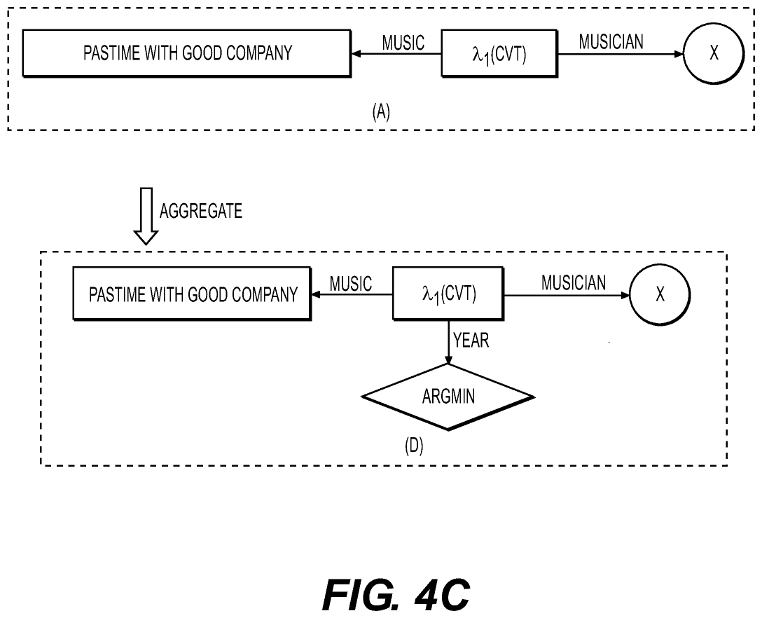

Referring now to FIGS. 4A-4C, additional information regarding the query graph generation process is presented. Once the relation and entities have been extracted, the system is configured to generate an appropriate query graph. In different embodiments, the system will apply one of three actions: extend/expand, connect, or aggregate. Each of these actions is directed towards growing the query graph g by one additional edge and one additional node.

In FIG. 4A, an extend or expand action is depicted. An extend action extends the core path by one or more relation in [symbol] . For a given topic entity e, this action finds a relation r linking to e and makes the other end the relation a lambda variable “x”. If the current query has a lambda variable x, then the variable is replaced with an existential node y. The action is then repeated as needed. Referring next to FIG. 4B, a connect action will be used in cases where the system identifies multiple grounded entities in the question, apart from the (head) topic entity. A connect action links these grounded entities with either a lambda node or an existential variable (e.g., a CVT node).

In FIG. 4C, an example of an aggregate action is shown. The aggregate action initially involves extraction of the constraints. In this case, temporal constraints and superlative linking are used, based on regular expressions and a superlative word list. These are mapped these to aggregation functions: argmin argmax. In this case, the step (d) is not a relevant query for the question, but is shown simply to illustrate aggregate action.

As another example of aggregate action, in the given question, “What is the oldest city in Florida?”, oldest is the superlative linking and it is mapped to argmin. For this approach, the function argmin is applied to a list of all of the cities in Florida to fetch the correct answer. An aggregate action attaches the detected aggregation function to either a lambda variable x or an existential variable connected to x (e.g., a CVT node). In different embodiments, the system initially applies the extend action, then the connect and/or aggregate actions. Such an approach significantly reduces the search space. These actions are repeated until the query graph is generated.

In different embodiments, the answer selection module can evaluate the set of query graphs produced by the system in order to select the correct answer. [symbol] represents the set of relations for each query graph g. There is also a set of relations [symbol] extracted from Equation (3) above. For g, the relation score is calculated by Equation (4):

RelScore_{g}=| [symbol] ∩ [symbol] |

The RelScore_{g} is combined with the Complex score to obtain the answer entity:

$${e}_{ans} = {argmax}_{{a}^{′} ∈ {N}_{g}} ϕ ( {e}_{h} , {e}_{q} , {e}_{{a}^{′}} ) + γ * {RelScore}_{g}$$

where γ is a tunable parameter. The entity with the highest score (eₐₙₛ) is selected as the final answer.

In order to evaluate the efficacy and accuracy of the proposed systems, comparisons against existing techniques across several datasets were performed. The datasets included WebQuestions, Semantic Parses (WQSP), ComplexQuestions (CQ), and ComplexWebQuestions (CWQ). At the time of these comparisons, CWQ included the highest percentage of complex questions with constraints and multiple hops. Table (1) below presents a comparison of the results between an embodiment of the proposed method and other conventional methods:

| Method | CWQ (Prec@1/F1) | WQSP (F1) | CQ (F1) |
|---|---|---|---|
| Yih et al. | NA | 69.0 | NA |
| Luo et/al. | NA | NA | 40.9 |
| Bao et al. | NA | NA | 42.8 |
| Lan et al. | 39.3/36.5 | 67.9 | NA |
| Bhutani et al. | 40.8/33.9 | 60.3 | NA |
| Chen et al. | 30.5/29.8 | 68.5 | 35.3 |
| Ansari et al. | NA | 72.6 | NA |
| Lan and Jiang | 44.1/40.4 | 74.0 | 43.3 |
| Proposed Method | 46.3/41.9 | 77.8 | 45.9 |

As shown above, the proposed method outperforms other methods on CWQ dataset in terms of both Prec@1 and F1. The proposed model also shows an improvement of 2.2% in terms of Prec@1 and 1.5% in terms of F1 compared to the best conventional model, validating the model's capability to effectively handle the complex questions with both constraints and multiple hops. With respect to the WQSP dataset, the percentage of constrained based questions are low, especially for multi hops (0.5%). For this reason, the proposed model not only outperforms all other conventional models but also displays around 74% F1 score, which is highest in comparison to the other two datasets (CWQ and CQ). The CQ dataset contains only single hop constrained based questions, and again the proposed model outperformed the conventional models in terms of F1 by 2.5%. These results underscore the effectiveness of the proposed model in terms of handling only constraint-based questions. In other words, the results clearly illustrate the robustness and efficiency of the proposed model.

An ablation study was also performed to provide greater insight to the proposed model's performance. For example, in order to demonstrate that the performance of the model was not simply a result of using ROBERTa, the ROBERTa was replaced with a simple GRU model and the experiments were re-conducted. As shown in Table (2) below, the GRU-based version shows comparable results with the conventional models in terms of both Prec@1 and F1, thereby verifying that the proposed model's performance is not dependent on ROBERTa.

| Method | CWQ (Prec@1/F1) |
|---|---|
| SOTA | 44.1/40.4 |
| w GRU | 43.3/38.6 |
| w/o extend | 26.4/22.8 |
| w/o connect | 36.8/32.3 |
| w/o aggregate | 43.8/39.5 |
| Freebase-50 (avg.) | 27.7/22.8 |
| TransE | 43.8/39.8 |
| TransH | 44.5/40.8 |

Table (2) also shows the results of the ablation in demonstrating the importance of the three actions (extend, connect, aggregate) on the generation of the query graph. Three variants of the proposed model were created in which one of the actions was eliminated. While aggregate action had the least effect among the three on performance, and extend action had the greatest effect on the performance, the highest score is obtained when all three actions are used together.

In addition, to show the effectiveness of the KG embedding module, 50% of the relations were randomly removed from the KG (in this case, Freebase) and used to produce a new “KG Freebase-50”. The proposed model was then applied using the KG Freebase-50. From the results in Table (2), with the reduced KG, the proposed model performs similarly to that of the “w/o extend” approach. This illustrates that the proposed model is able to predict missing links correctly.

Finally, to demonstrate the effect of the embedding model on the proposed systems, two new variants of the model were created using TransE and TransH KG embeddings. The results are also shown in Table (2). Both models produce comparable results with respect to conventional techniques, showing performance of the proposed method is not mainly dependent on the type of KG embeddings used.

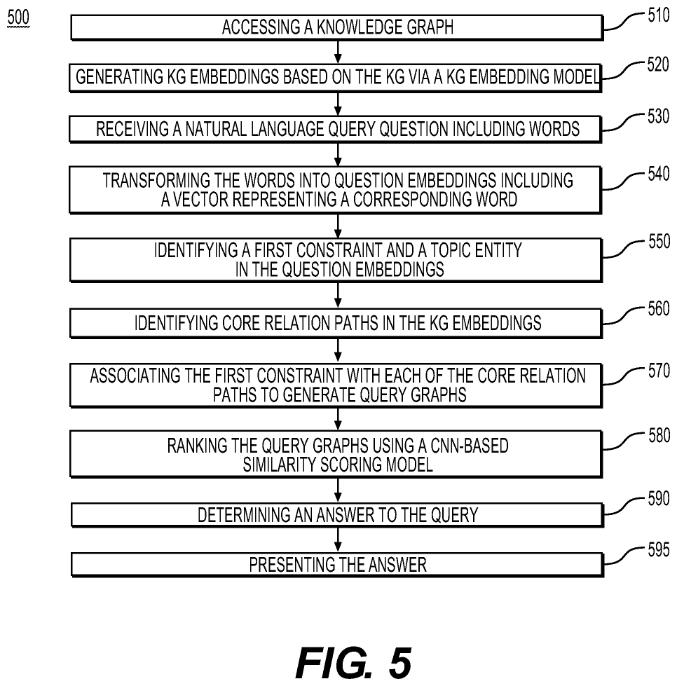

FIG. 5 is a flow chart illustrating an embodiment of a method 500 of generating answers to multi-hop constraint-based questions by a question-and-answer system (QAS) using knowledge graphs. As shown in FIG. 5, a first step 510 of the method 500 includes accessing, by a question-and-answer system (QAS), a knowledge graph. The QAS can be hosted, for example, on a cloud-server or a local computing device. The KG can be part of the QAS or external to the QAS, or be generated by the QAS based on a given ontology. A second step 520 includes generating, at the QAS, a set of knowledge graph embeddings based on the knowledge graph via a knowledge graph embedding model, and a third step 530 includes receiving, at the QAS and from a user device, a natural language query question having one or more words. The method 500 also includes a fourth step 540 of transforming, at the QAS, the one or more words into one or more question embeddings, where each embedding is a vector representing a corresponding word, and a fifth step 550 of identifying, at the QAS, at least a first constraint and a topic entity in the question embeddings. A sixth step 560 includes identifying, at the QAS, a plurality of core relation paths in the knowledge graph embeddings, where each path links the topic entity to a different ungrounded entity, and a seventh step 570 includes associating, at the QAS, the first constraint with each of the core relation paths to generate a plurality of query graphs including at least a first query graph, where each query graph is based on a combination of question embeddings and knowledge graph embeddings. The method 500 further includes an eighth step 580 of ranking, at the QAS, the plurality of query graphs using a CNN-based similarity scoring model, a ninth step 590 of determining, based on a top-ranked query graph and at the QAS, an answer to the query, and a tenth step 592 of presenting, via the user device and from the QAS, the answer.

In other embodiments, the method may include additional steps or aspects. In some embodiments, the method also includes outputting a natural language response to the query, for example for display on a computer screen. In different embodiments, the disclosed system and method may be part of a natural language understanding system or a spoken language understanding system. In some embodiments, the method also includes a step of extending a first core relation path by linking the topic entity to an ungrounded entity, thereby generating the first query graph. In such cases, the method may further include a step of connecting a first grounded entity of to either a lambda variable or an existential variable and/or steps of mapping the first constraint to an aggregation function, and attaching the mapped first constraint to either a lambda variable or an existential variable connected to the lambda variable, thereby generating the first query graph.

In another example, the method can additionally include steps of learning, at the QAS, a linking model based on training data and an ontology for the training data, processing, at the QAS, the knowledge graph embeddings via the linking model, generating, at the QAS, a new knowledge graph embedding based on output of the linking model, and adding the new knowledge graph embedding to the set of knowledge graph embeddings. In one example, the set of knowledge graph embeddings includes entity embeddings and relation embeddings. In some embodiments, the method also includes steps of extracting superlative linking in the question embeddings, and mapping the superlative linking to an aggregation function.

In some embodiments, the system may generate the natural language response based on the highest ranked query graph. For example, the system may convert the information in the query graph into a natural language word or set of words (i.e., a sentence). The system may apply natural language generation (i.e., content determination, sentence structuring, aggregation, lexical choice, referring expression generation, etc.) to convert the query graph into the natural language response. In some embodiments, the system may display the natural language response. For example, the system may communicate the natural language response to a device to display a graphical user interface. In some examples, the system may also communicate instructions to the device, which cause the device to display the natural language response. In different embodiments, the systems described herein may be implemented with additional, different, or fewer components than illustrated. Each component may include additional, different, or fewer components.

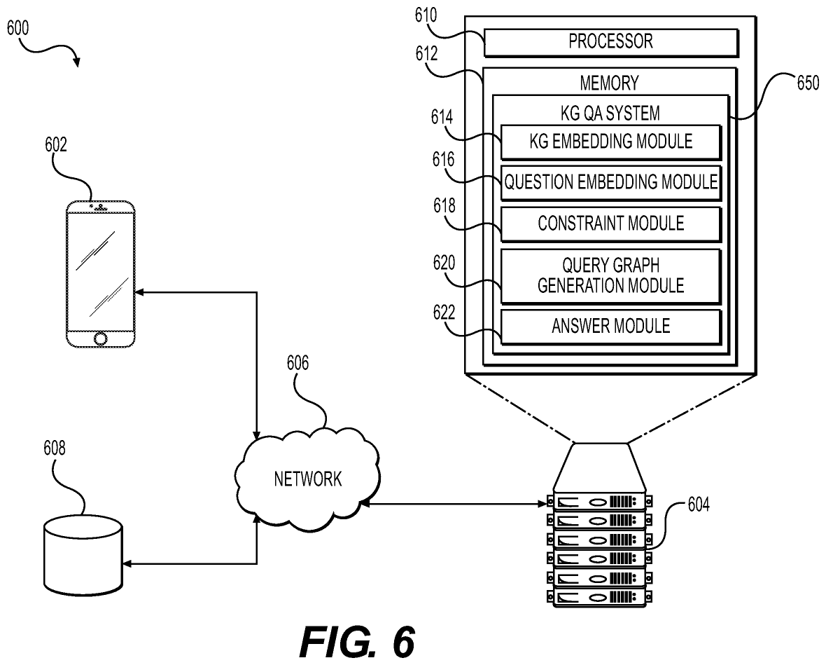

An embodiment of a system 600 for automatically generating responses to user input queries based on an embodiment of the KGQA model disclosed herein is shown in FIG. 6. As depicted in FIG. 6, a user computing device (“computing device”) 602 associated with a user represents any device executing computer executable program code (e.g., as application programs, operating system functionality, or both) to implement the operations and functionality associated with the computing device 602. The computing device 602 may include a mobile computing device or any other portable device. In some examples, the mobile computing device includes a mobile telephone, laptop, tablet, computing pad, netbook, gaming device, and/or portable media player. The computing device 602 may also include more stationary devices such as desktop personal computers, kiosks, tabletop devices, etc.

In some examples, the computing device 602 includes a communications interface component. The communications interface component includes a network interface card and/or computer-executable instructions (e.g., a driver) for operating the network interface card. Communication between the computing device 602 and other devices may occur using any protocol or mechanism over any wired or wireless connection. In some examples, the communications interface component is operable with short range communication technologies, such as by using near-field communication (NFC) tags. Computing device 602 also includes input devices such as one or of a keyboard, a mouse, a touch screen, a microphone, a camera, a graphical user interface, or any other type of input device. Output device(s) of computing device 602 may include, without limitation, a display screen, a graphical user interface, a speaker, or any other type of output device.

In some embodiments, the computing device 602 may optionally include or otherwise be configured to access a digital assistant, for example via network 606. The digital assistant can include a conversational agent or other response generation system capable of communicating with a user using natural language responses to user queries and messages. Furthermore, computing device 602 may optionally connect to a server computing system (“computing system”) 604 via network 606 and a database 608 (e.g., knowledge graph database). The network 606 may include any type of network connection. In one example, the network 606 may refer to the Internet, an intranet, an Ethernet, or other wireless or hardwired connections by which devices may send and receive data.

While FIG. 6 shows one user device, it is understood that one or more user devices may be used. For example, in some embodiments, the system may include two or three user devices. The user may include an individual seeking to obtain answers to their queries. In some embodiments, the user device may be a computing device used by a user. For example, the user device may include a smartphone or a tablet computer. In other examples, user device may include a laptop computer, a desktop computer, and/or another type of computing device. The user devices may be used for inputting, processing, and displaying information. In some embodiments, a digital camera may be used to generate live video images used for analysis in the disclosed method. In some embodiments, the user device may include a digital camera that is separate from the computing device. In other embodiments, the user device may include a digital camera that is integral with the computing device, such as a camera on a smartphone, laptop, or tablet.

In different embodiments, a multi-hop constraint-based knowledge graph question and answer system (“KGQA system”) 650 may be hosted in computing system 604, which may have a memory 612 and a processor 610. Processor 610 may include a single device processor located on a single device, or it may include multiple device processors located on one or more physical devices. Memory 612 may include any type of storage, which may be physically located on one physical device, or on multiple physical devices. In some cases, computing system 604 may comprise one or more servers that are used to host the KGQA system 650. In addition, the processor 610 is programmed to execute computer executable program code for implementing aspects of the disclosure. The computer executable program code includes instructions that may be performed by the processor 612 within the computing system 604, or performed by a processor external to the computing system 604. In some examples, the processor 610 is programmed to execute instructions such as those illustrated in the figures above.

Furthermore, memory 612 stores one or more computer-executable components that can comprise the KGQA system 650. Some example components include, without limitation, a user input module, and an extraction component, a KG embedding module 614, a question embedding module 616, a constraint module 618, a query graph generation module 620, and an answer module 622. In some embodiments, memory 612 further stores model training components. The answer module 622, when executed by the processor 610 of the computing system 604, causes the processor to generate an answer to a query received via the user input module. In some embodiments, answer module 622 generates a response to user generated queries. In some examples, the KGQA system 650 includes a machine learning model. The machine learning model may include a neural network model. In some embodiments, the neural network uses a Recurrent Neural Network Language Model (RLM) architecture. In one embodiment, the RLM model architecture and/or the response generation engine architecture can be configured as completely data-driven and can easily be trained end-to-end using unstructured conversational data without requiring human annotation, scripting, or automatic parsing. The memory 612 may optionally store an extraction component for performing the entity extraction and linking techniques described herein as well as conversion and generation of data. The computing system 604 may also optionally store and/or access data stored on remote data storage, also referred to herein as the KG database 608. The KG database 608 may be any type of data storage system, such as, but without limitation, a cloud storage system.

The number and arrangement of components shown in FIG. 6 are provided as an example. In practice, the system may include additional components, fewer components, different components, or differently arranged components than those shown in FIG. 6. Additionally, or alternatively, a set of components (e.g., one or more components) of the system may perform one or more functions described as being performed by another set of components of the system.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

This disclosure includes and contemplates combinations with features and elements known to the average artisan in the art. The embodiments, features and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

While various embodiments are described, the description is intended to be exemplary, rather than limiting and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted. Also, various modifications and changes may be made within the scope of the attached claims.

We claim:

1. A computer-implemented method of generating answers to multi-hop constraint-based questions by a question-and-answer system (QAS) using knowledge graphs, comprising:
accessing, by a QAS, a knowledge graph;
generating, at the QAS, a set of knowledge graph embeddings based on the knowledge graph via a knowledge graph embedding model;
receiving, at the QAS and from a user device, a natural language query question having one or more words;
transforming, at the QAS, the one or more words into one or more question embeddings, each embedding being a vector representing a corresponding word;
identifying, at the QAS, at least a first constraint and a topic entity in the question embeddings;
identifying, at the QAS, a plurality of core relation paths in the knowledge graph embeddings, each path linking the topic entity to a different ungrounded entity;
associating, at the QAS, the first constraint with each of the core relation paths to generate a plurality of query graphs including at least a first query graph, each query graph being based on a combination of question embeddings and knowledge graph embeddings;
ranking, at the QAS, the plurality of query graphs using a CNN-based similarity scoring model;
determining, based on a top-ranked query graph and at the QAS, an answer to the query; and
presenting, via the user device and from the QAS, the answer.

2. The method of claim 1, further comprising extending a first core relation path by linking the topic entity to an ungrounded entity, thereby generating the first query graph.

3. The method of claim 2, further comprising connecting a first grounded entity of to either a lambda variable or an existential variable.

4. The method of claim 2, further comprising:
mapping the first constraint to an aggregation function; and
attaching the mapped first constraint to either a lambda variable or an existential variable connected to the lambda variable, thereby generating the first query graph.

5. The method of claim 1, further comprising:
learning, at the QAS, a linking model based on training data and an ontology for the training data;
processing, at the QAS, the knowledge graph embeddings via the linking model;
generating, at the QAS, a new knowledge graph embedding based on output of the linking model; and
adding the new knowledge graph embedding to the set of knowledge graph embeddings.

6. The method of claim 1, wherein the set of knowledge graph embeddings includes entity embeddings and relation embeddings.

7. The method of claim 1, further comprising:
extracting superlative linking in the question embeddings; and
mapping the superlative linking to an aggregation function.

8. A non-transitory computer-readable medium storing software comprising instructions executable by one or more computers which, upon such execution, cause the one or more computers to:
access, by a question-and-answer system (QAS), a knowledge graph;
generate, at the QAS, a set of knowledge graph embeddings based on the knowledge graph via a knowledge graph embedding model;
receive, at the QAS and from a user device, a natural language query question having one or more words;
transform, at the QAS, the one or more words into one or more question embeddings, each embedding being a vector representing a corresponding word;
identify, at the QAS, at least a first constraint and a topic entity in the question embeddings;
identify, at the QAS, a plurality of core relation paths in the knowledge graph embeddings, each path linking the topic entity to a different ungrounded entity;
associate, at the QAS, the first constraint with each of the core relation paths to generate a plurality of query graphs including at least a first query graph, each query graph being based on a combination of question embeddings and knowledge graph embeddings;
rank, at the QAS, the plurality of query graphs using a CNN-based similarity scoring model;
determine, based on a top-ranked query graph and at the QAS, an answer to the query; and
present, via the user device and from the QAS, the answer.

9. The non-transitory computer-readable medium storing software of claim 8, wherein the instructions further cause the one or more computers to extend a first core relation path by linking the topic entity to an ungrounded entity, thereby generating the first query graph.

10. The non-transitory computer-readable medium storing software of claim 9, wherein the instructions further cause the one or more computers to connect a first grounded entity of the first query graph to either a lambda variable or an existential variable.

11. The non-transitory computer-readable medium storing software of claim 9, wherein the instructions further cause the one or more computers to:
map the first constraint to an aggregation function; and
attach the mapped first constraint to either a lambda variable or an existential variable connected to the lambda variable, thereby generating the first query graph.

12. The non-transitory computer-readable medium storing software of claim 8, wherein the instructions further cause the one or more computers to:
learn, at the QAS, a linking model based on training data and an ontology for the training data;
processing, at the QAS, the knowledge graph embeddings via the linking model;
generate, at the QAS, a new knowledge graph embedding based on output of the linking model; and
add the new knowledge graph embedding to the set of knowledge graph embeddings.

13. The non-transitory computer-readable medium storing software of claim 8, wherein the set of knowledge graph embeddings includes entity embeddings and relation embeddings.

14. The non-transitory computer-readable medium storing software of claim 8, wherein the instructions further cause the one or more computers to:
extract superlative linking in the question embeddings; and
map the superlative linking to an aggregation function.

15. A system for generating answers to multi-hop constraint-based questions comprising:
one or more computers and one or more storage devices storing instructions that are operable, when executed by the one or more computers, to cause the one or more computers to:
access, by a question-and-answer system (QAS), a knowledge graph;
generate, at the QAS, a set of knowledge graph embeddings based on the knowledge graph via a knowledge graph embedding model;
receive, at the QAS and from a user device, a natural language query question having one or more words;
transform, at the QAS, the one or more words into one or more question embeddings, each embedding being a vector representing a corresponding word;
identify, at the QAS, at least a first constraint and a topic entity in the question embeddings;
identify, at the QAS, a plurality of core relation paths in the knowledge graph embeddings, each path linking the topic entity to a different ungrounded entity;
associate, at the QAS, the first constraint with each of the core relation paths to generate a plurality of query graphs including at least a first query graph, each query graph being based on a combination of question embeddings and knowledge graph embeddings;
rank, at the QAS, the plurality of query graphs using a CNN-based similarity scoring model;
determine, based on a top-ranked query graph and at the QAS, an answer to the query; and
present, via the user device and from the QAS, the answer.

16. The system of claim 15, wherein the instructions further cause the one or more computers to extend a first core relation path by linking the topic entity to an ungrounded entity, thereby generating the first query graph.

17. The system of claim 16, wherein the instructions further cause the one or more computers to connect a first grounded entity of the first query graph to either a lambda variable or an existential variable.

18. The system of claim 16, wherein the instructions further cause the one or more computers to:
map the first constraint to an aggregation function; and
attach the mapped first constraint to either a lambda variable or an existential variable connected to the lambda variable, thereby generating the first query graph.

19. The system of claim 15, wherein the instructions further cause the one or more computers to:
learn, at the QAS, a linking model based on training data and an ontology for the training data;
processing, at the QAS, the knowledge graph embeddings via the linking model;
generate, at the QAS, a new knowledge graph embedding based on output of the linking model; and
add the new knowledge graph embedding to the set of knowledge graph embeddings.

20. The system of claim 15, wherein the set of knowledge graph embeddings includes entity embeddings and relation embeddings.
